(19) United States
(12) Patent Application Publication
(10) Pub. No.: US 2019/0123371 A1
(43) Pub. Date: Apr. 25, 2019

(54) POLY-GENERATING FUEL CELL WITH THERMALLY BALANCING FUEL PROCESSING

(71) Applicant: WASHINGTON STATE UNIVERSITY, Pullman, WA (US)

(72) Inventor: Dustin Fogle McLarty, DeLand, FL (US)

(21) Appl. No.: 16/163,739

(22) Filed: Oct. 18, 2018

Related U.S. Application Data
(63) Continuation of application No. 14/642,438, filed on Mar. 9, 2015, now abandoned.
(60) Provisional application No. 61/973,826, filed on Apr. 1, 2014.

(51) Int. Cl. H01M 8/0656; H01M 8/0432; H01M 8/04014; H01M 8/04858; H01M 8/04746; H01M 8/0612; H01M 8/0668; H01M 8/04992

(52) U.S. Cl. CPC H01M 8/0656; H01M 8/04365; H01M 8/04014; H01M 8/0491; H01M 2008/147; H01M 8/0618; H01M 8/0668; H01M 8/04992; H01M 8/04753

(57) ABSTRACT

A fuel cell system and methods are disclosed to co-produce electricity, heat, hydrogen fuel, and liquefied CO₂ by synergistically integrating one or more of a cryogenic air separation unit (ASU), a high temperature fuel cell, and a hydrogen separation unit (HSU).

### CROSS-REFERENCE TO RELATED APPLICATIONS

This application claims priority to, and the benefit of, U.S. provisional patent application Ser. No. 61/973,826 filed on Apr. 1, 2014, incorporated herein by reference in its entirety.

### STATEMENT REGARDING FEDERALLY SPONSORED RESEARCH OR DEVELOPMENT

Not Applicable

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

This description pertains generally to fuel cells, and more particularly to a poly-generation fuel cell.

### 2. Background Discussion

Among numerous attempts to improve fuel cell system performance have been three innovations with particular benefits: pressurization, air separation, and poly-generation. Pressurization results in substantial voltage improvement, but the parasitic compression penalty counter-balances the benefits. Air separation similarly improves voltage, but is counter-balanced by air separation energy and capital costs while introducing stack cooling challenges. Poly-generation can synergistically produce electricity, heat and fuel, but is counter-balanced by the complexity and inefficiency of current hydrogen separation and recovery systems.

Accordingly, an object of the preset description is a system that synergistically combines all three innovations with a novel systems integration approach to realize the benefits while avoiding the drawbacks that penalized each innovation when introduced individually.

### BRIEF SUMMARY

An aspect of the Oxy-FC system presently described is the integration of cryogenic air separation with a high temperature fuel cell. Utilizing a pure O₂ stream avoids the high compression penalties of other pressurized fuel cell systems by compressing only the oxygen necessary for the electrochemistry. Compared to a standard fuel cell using air cooling with an O₂ utilization of 33%, fully utilizing a pure O₂ stream results in a 93% reduction in the pressurized mass flow. The air-separation supports the system in a number of ways: improving voltage by providing purified oxygen (which may comprise pure or substantially pure oxygen) to the cathode, recovering both hydrogen and liquid CO₂ by providing cryogenic refrigeration, etc.

The complexity and inefficiency of hydrogen recovery in a poly-generating fuel cell is replaced in the system of the present description by a series of condensing heat exchangers that remove water and CO₂ as liquids, using the liquid nitrogen byproduct of the air separation. The CO₂ liquefaction is a distinguishing feature of the system of the present description, and is instrumental to the cycle, while readily enabling carbon capture for sequestration, enhanced oil recovery, or other uses.

The resulting integrated system has the potential to simultaneously increase the power density of a fuel cell by 50%, reduce fuel use by more than 20%, and increase the value of products by 48% by monetizing electricity, hydrogen, and carbon dioxide. Successful deployment of the Oxy-FC technology at a commercial scale would place an abundant source of inexpensive, carbon neutral, electricity and hydrogen fuel in direct proximity to urban electric power and hydrogen fueling demand.

In one aspect, the system of the present description embodies thermodynamically integrating cryogenic air separation with high temperature electro-chemistry and fuel processing, which results in several synergies, including the following advantages:

(1) Increased electrochemical potential, resulting from the 400% increase in O₂ concentration and pressurization of the cathode.

(2) Increased electrochemical potential resulting from the increased anode reactant concentration necessary to sustain thermal equilibrium within the stack.

(3) Ultra-high recovery potential (near 100%) for efficient co-production of hydrogen due to cryogenic methods and the reduced fuel utilization necessary for stack thermal management.

(4) Ultra-efficient carbon-neutral power generation resulting from the cryogenic recovery of liquefied CO₂ using waste nitrogen from the air-separation process.

(5) Significantly reduced compression parasitic and heat exchanger bulk for compressing and preheating the oxidant stream, due to the >90% reduction in oxidant stream mass flow.

(6) Increased transient load following potential due to the closer physical coupling of the electrochemical heat generation and the fuel processing heat sink.

The system of the present description achieves high 65% to 75% (LHV) FTE efficiency at large scales, while simultaneously recovering high purity Hydrogen and liquid CO₂ with minimal parasitic load. At the large scale, FTE efficiency can be further improved 3% by electricity production from recovered high quality heat and 8% to 15% from recovered hydrogen through a separate low temperature fuel cell system, resulting in a net FTE efficiency of 80% to 85%.

The systems of the present description may be used with either solid oxide or molten carbonate fuel cell (MCFC) variations. The charge transport ion of MCFC technology, CO₃″, uses injection of recovered CO₂ into the pure O₂ stream supplied by the air separation unit. This recirculation of CO₂ effectively doubles the mass flow of CO₂ that is condensed from the anode tail gas. Additional liquid nitrogen is produced to provide sufficient cryogenic cooling to perform this liquefaction.

In one alternative embodiment, an Oxy-FC system incorporates an electrolyzer instead of a cryogenic air separation unit. In such embodiment, carbon recovery is not inherent in the design, and alternative technologies such as pressure-swing-absorption can recover both hydrogen and carbon dioxide from the anode exhaust.

The systems and methods of the present description solve a number of challenges, such as thermal management in the absence of an air-cooled cathode. A unique control strategy is employed using the predicted thermal balance between fuel processing and power generation to simultaneously adjust both fuel flow and current. This controller permits the system to operate in a load-following manner, but requires a means of variable anode recirculation. Variable speed blowers and ejectors can provide this flexibility. A reciprocating pump with variable valve timing is described which would benefit the described system by simultaneously supplying the anode compression, fuel hydration, and pre-heating.

Further aspects of the technology will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1 shows a schematic system diagram for the integrated fuel cell system of the present disclosure, including the three primary components: the air separation unit (ASU), fuel cell (FC), and CO₂ liquefaction/hydrogen separation unit (HSU).

FIG. 2 is a schematic system diagram for an alternative embodiment of the system of FIG. 1 which does not employ cryogenic air separation or carbon-capture.

FIG. 3A through FIG. 3D are schematic diagrams illustrating the integration of a high temperature, pressurized, fuel cell with a reciprocating pump that simultaneously provides the fuel hydration, pre-heating, and compression.

FIG. 4 is a schematic diagram of the balance-of-plant (BoP) system components incorporating a commercial Oxy-FC installation in accordance with the present description.

FIG. 5 is a schematic flow diagram for a fuel and current controller configured to simultaneously manage the power output and thermal transients of the fuel cell.

FIG. 6 is a plot illustrating functionality of the controller with respect to modulating current, voltage, and fuel utilization across a range of power outputs to maintain a constant stack temperature.

### DETAILED DESCRIPTION

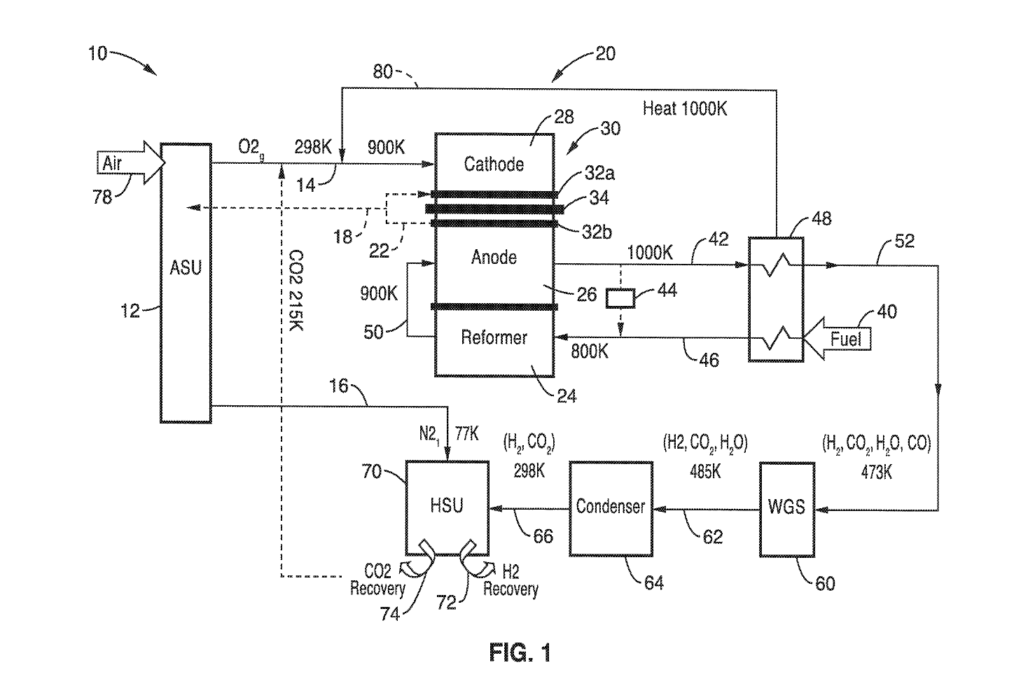

FIG. 1 shows a schematic diagram of an integrated high-temperature fuel cell system 10 in accordance with the present description which co-produces electricity, heat, hydrogen fuel, and liquefied CO₂ by synergistically integrating a cryogenic air separation unit (ASU) 12, a high temperature fuel cell 20, and a hydrogen separation unit (HSU) 70.

Integrated fuel cell system 10 comprises an air separation unit 12 that is uses air 78 to simultaneously produce gaseous oxygen 14 and liquid nitrogen 16, delivering gaseous high pressure oxygen 14 as a feedstock to the fuel cell 20. Electric load 22 is applied to the fuel cell 20. A portion of the generated electricity 18 from fuel cell 20 may be used in operation of the ASU 12.

In exemplary embodiments, the high temperature fuel cell 20 may include molten carbonate or solid oxide configurations, which readily scale from the residential (1 kW) to industrial sizes (10-100 MW).

In the case of a molten carbonate fuel cell, recovered CO₂ from the anode stream is added to the high pressure oxidant feedstock 14 at a molar ratio of 2:1 to form CO₃ transport ions in the cathode 28. This has the effect of increasing the anode 26 exhaust CO₂ concentration and increasing the cryogenic cooling load of the hydrogen separation. As seen in FIG. 1, CO₂ may be supplied from recovered CO₂ 74 from the HSU 70.

To achieve sufficient stack cooling, excess natural gas 40 is provided to the fuel cell 20. This serves to increase the hydrogen concentration throughout the anode channels, again benefiting fuel cell 20 performance. While the exemplary embodiments disclosed herein use natural gas as the energy feedstock, a similar hydrocarbon fuel such as high methane content biogas (e.g. landfill gas, digester gas, etc.) could be readily substituted with the appropriate gas-cleanup technology.

Natural gas or fuel 40 is supplied to the fuel cell 20, where it mixes with sufficient anode recirculation 44 to reach a temperature suitable for the fuel cell 20. The fuel mixture passes through a reformer 24, wherein the hydrocarbons are converted to carbon monoxide, carbon dioxide and hydrogen through a combination of steam reforming and water-gas-shift chemistry. The fuel mixture 50, now rich in hydrogen, is supplied to the anode gas channels 26. Power is produced from the fuel cell which is comprised of a plurality of repeating cell units. A positive electrode 32a, an electrolyte 34, and a negative electrode 32b (PEN) assembly 30 are placed between each set of bi-polar plates to comprise a single repeating-cell-unit of the fuel cell. The cathode 28 may be supplied with pre-heated gaseous oxygen 14, the heat 80 being delivered from heat exchanger 48.

A purge valve (not shown) may also be provided to remove the buildup of contaminants, namely argon. The fuel 42 exits the anode with a lower hydrogen content, but higher water content. The fuel 42 is split into two streams; a portion is re-circulated into the reformer 24 via an ejector, blower or reciprocating pump 44 with fuel 40 to form fuel mixture 46, the remainder of the fuel passes through a heat exchanger 48, which may generate high pressure steam or hot air 80 to pre-heat the oxygen 14.

The cooled fuel 52 passes through one or more water-gas-shift-reactors 60 which convert any remaining carbon monoxide into carbon dioxide and hydrogen. The fuel 62 is then cooled by ambient air or water such that the majority of the water present in the fuel stream is condensed and removed via condenser 64.

The remaining fuel of the dehumidified anode stream 66, a combination of mostly hydrogen (H₂) and carbon dioxide (CO₂), is separated by hydrogen separation unit (HSU) 70. While other technologies may be used for this separation (e.g. less energy intensive means such as pressure swing absorption), a preferred embodiment of the present description involves cryogenically cooling the fuel stream 66 with the liquid nitrogen 16 co-produced in the ASU 12 with the gaseous oxygen 14 to separate the fuel into gaseous hydrogen 72 and liquid carbon dioxide 74. The resulting high-purity hydrogen 72 and liquefied CO₂ 74 are then recovered. The flow rate of liquid N₂ 16 (boiling temperature of 77.4 K) produced in the ASU 12 for a specified oxygen production is more than sufficient to fully condense the mass flow of CO₂ 74 (boiling temperature of 216.6 K) in the anode tail gas.

Because the fuel cell stack 20 cooling is provided primarily by the endothermic reforming of a hydrocarbon fuel such as natural gas, the cathode 28 can be closed-ended. This increases oxygen partial pressure in the cathode 28 and raises oxygen utilization to 100%. This provides a synergistic benefit to the fuel cell 20 in the form of higher Nernst potential and reduced diffusion losses. The cathode 28 flow rate, reduced by a factor of 20, can be pressurized with minimal parasitic load, providing a further benefit to the fuel cell performance. The ultra-high co-production efficiency and ultra-low greenhouse gas (GHG) and pollutant emissions characterize this transformative technology which could be competitive under present energy rates and regulations while benefiting from stricter future GHG and pollutant emission standards.

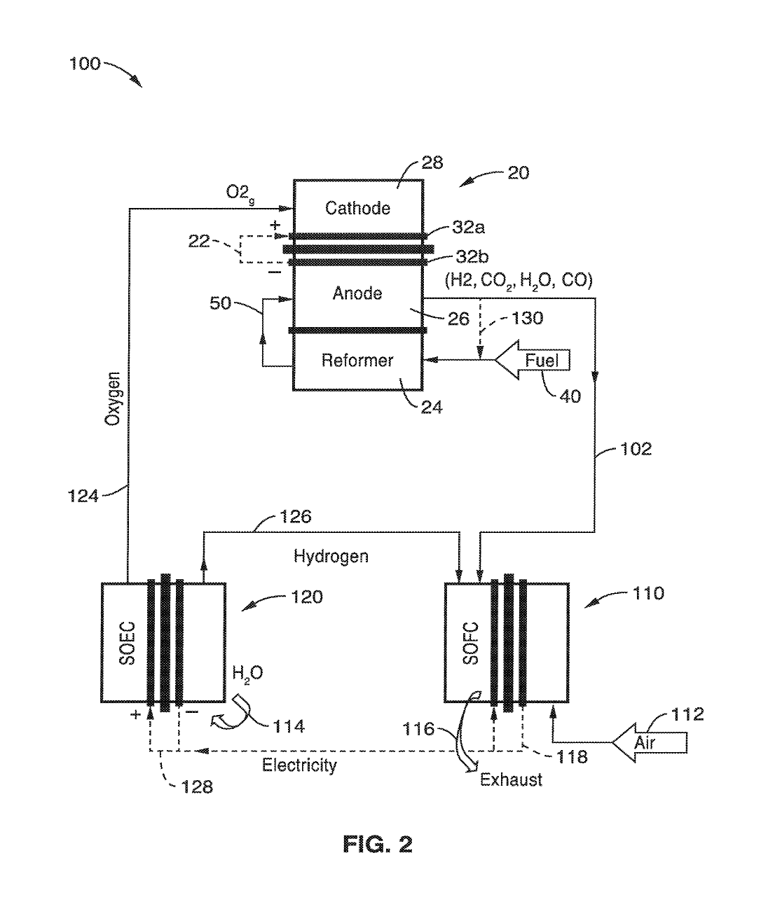

FIG. 2 shows a schematic diagram of an alternative configuration of an Oxy-FC system 100 that relies on electrolysis to generate oxygen 124 for the cathode 28. Power for the electrolysis is produced in a second high temperature fuel cell 110. Unlike system 10 of FIG. 1, system 110 is cooled by the cathode 28 air flow 112 and operates at considerably lower voltage. The anode exhaust 102 of the primary fuel cell 20 provides the fuel stream for this secondary fuel cell 110 (shown as a solid-oxide fuel cell (SOFC) in FIG. 2).

Electrolytic conversion is achieved via a solid oxide electrolyzer cell (SOEC) 120, which generally comprises a solid oxide fuel cell that runs in regenerative mode to achieve the electrolysis of water 114 and via a solid oxide, or ceramic, electrolyte to produce oxygen 124 and hydrogen gas 126. The hydrogen by-product 126 of the electrolysis can either be captured and stored, or utilized within the secondary fuel cell 110, depending upon the operating conditions of all three sub-systems. This configuration does not inherently capture CO₂ as part of the hydrogen recovery process; however, carbon-capture can readily be added to the exhaust 116 of the secondary fuel cell 110, the product of which is primarily water and carbon dioxide. Loads 118 and 128 are applied to fuel cells 110 and 120, respectively.

Reformed fuel 50 is supplied to anode 26 via reformer 24. A portion 130 of the anode output stream 102 may also be re-circulated, e.g. with use of a reciprocating pump 44 as shown in FIG. 1 into fuel 40 to reach a temperature suitable for the fuel cell 20.

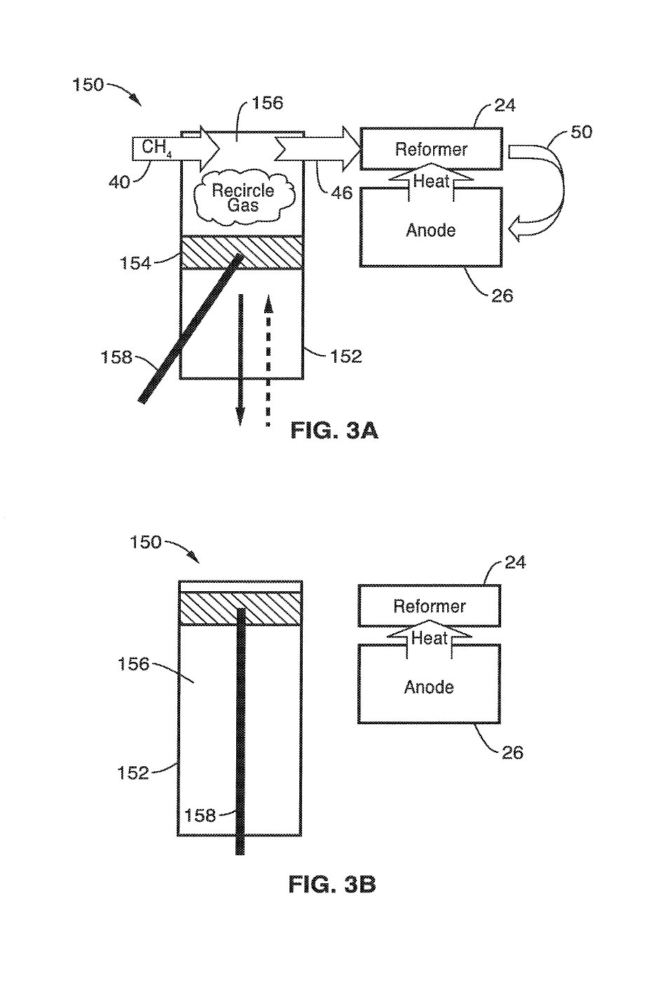

FIG. 3A through FIG. 3D show schematic diagrams of a reciprocating pump 150 (e.g. for use as the ejector, blower or reciprocating pump 44 in FIG. 1) for combining and controlling the pressurization, humidification, and pre-heat of the anode stream. The reciprocating pump 150 utilizes variable valve timing to control the portion of residual anode exhaust 42, which is mixed with fresh fuel 40 prior to compression. In the first step illustrated in FIG. 3A, corresponding to the intake/compression phase, the fresh fuel 40 (e.g. CH₄ or bio-gas) is added to the split portion of the residual anode exhaust 42. Piston 154 and rod 158 is then reciprocated to compress mixture 46 in chamber 156 of container 152 and into the high pressure reformer 24.

In the second step illustrated in FIG. 3B, corresponding to the high pressure electrochemistry phase, the fuel mixture 46 is given sufficient time within the reformer 24 and anode 26 to undergo reformation and water-gas-shift, producing hydrogen in mixed fuel 50, along with electrochemical reactions that produce electricity. In the third step illustrated in FIG. 3C, corresponding to the expansion phase, the high pressure anode exhaust 42 is expanded within chamber 156, and provides the power for the next compression stroke. In the fourth step illustrated in FIG. 3D, corresponding to the exhaust phase, the portion of the anode flow 42 that is not be re-circulated through the anode 26 is exhausted. The variable valve timing allows the proportion of residual gas to be controlled prior to the next fuel injection step.

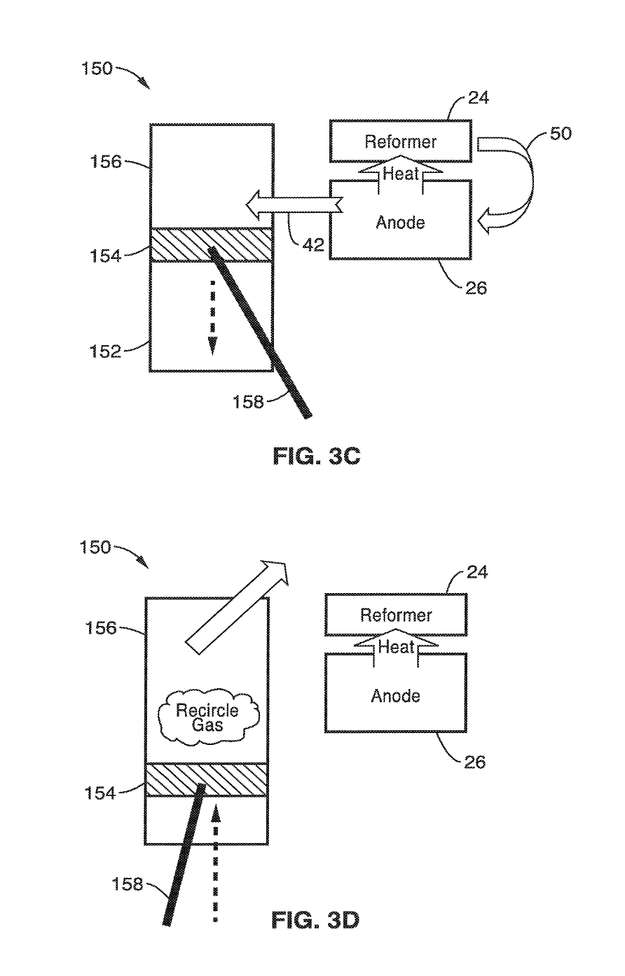

Referring now to FIG. 4, a schematic diagram of a power generation block 200 is shown, comprising an air separation unit 210, a fuel cell 230, and a hydrogen separation unit 250. The power generation block 200 is further integrated with associated electric and fuel balance of plant components. A fuel compressor 232 and storage tank 234 are used for holding fuel 40. An oxygen compressor 214 and corresponding storage tank 212 are also included for storing O₂ 14 produced by the ASU 210 prior to use with the fuel cell 230. Similarly, a nitrogen compressor 220 and corresponding storage tank 222 may be used for storing N₂ 16 generated by ASU 210.

The hydrogen 72 exiting the hydrogen separation unit 250 is further purified and compressed with hydrogen purifier 252 and compressor 254 before being sent to a pipeline and storage tank 256, secondary fuel cell 260, combustor 262, steam turbine 264 and associated generator (not shown).

Electrical generation 18 from the fuel cell 230 is conditioned with a low voltage power conditioner 260 and the voltage adjusted at voltage transformer 264 for either a direct DC load or for charging batteries 266. The fuel cell electricity can also be sent to a DC/AC converter 262 for interconnecting with AC power transmission.

The steam generated by the fuel cell 230 (e.g. steam 80 shown in FIG. 1) may be used in a steam turbine (e.g. such as turbine 264) to generate additional electricity.

In some embodiments, the high purity H₂ 72 can be used on-site, or sold for transportation applications, providing a second revenue stream after electric sales. The liquefied CO₂ 74 can be either sequestered for carbon neutral power generation or sold for industrial applications such as enhanced oil recovery. The resulting poly-generation produces electricity, heat, hydrogen, and liquid CO₂ in various ratios depending upon the fuel cell voltage, pressure and power density.

The closed-cathode design of the oxygen blown fuel cell lends itself to several new stack design and manifolding configurations, each providing inherent benefits. For thermal integration with the fuel reforming process, it is important to integrate the fuel processing components (e.g. reformer 24 reactor) into the fuel cell stack design. Ideally the fuel processing components would be tailored to locate the bulk of the endothermic reforming process near the areas of high current density, thereby minimizing thermal gradients in the fuel cell stack, reducing mechanical stress and entropy generation across the cell.

The thermodynamic analysis (discussed in further detail below) of the fuel cell system of the present disclosure indicates significant benefit to pressurized operation, which can be achieved with little compression work penalty due to the very low cathode flow rate. As such, stack manifolding designs would benefit from high pressure operation. The need for intricate channel routing across the plate is removed because the cathode channels are supplied with pure O₂ and will not see any concentration drop in the bulk flow, while the anode employs a high degree of recirculation to maintain fuel hydration and therefore also sees minimal reactant concentration drop in the bulk flow.

Existing cylindrical or rectangular planar stack geometries would benefit from the lack of cathode air routing that the system of the present disclosure allows. Cylindrical designs with a circumferential anode flow pattern would also benefit from placing the fuel reformer 26 entrance in direct proximity to the high current region at the anode 24 entrance. Cylindrical designs would also maximize the available volume within a pressurized vessel.

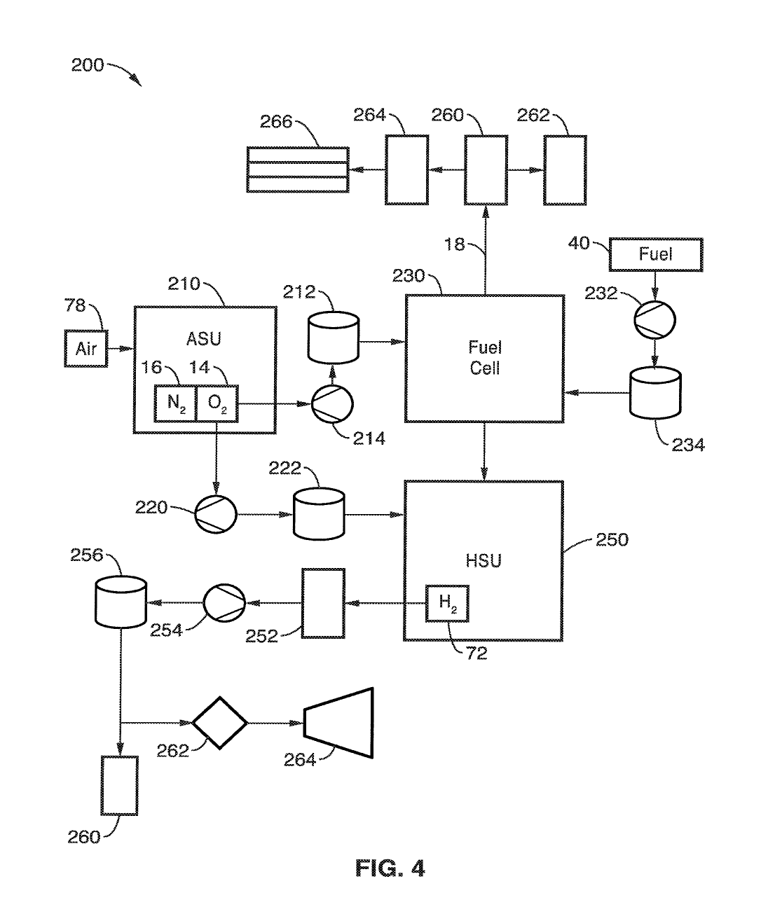

Utilizing the fuel stream as the primary means of stack thermal management results in a highly coupled interaction between power output, fuel flow and temperature. An embodiment of the present description preferably incorporates a combined power and thermal management controller 300 detailed in the schematic diagram of FIG. 5. The basis of controller 300 is Eq. 1 below, which relates voltage to both the stack heat generation and the fuel processing heat sink. Eq.1 assumes the electrical power output of the fuel stack 20 must be the combustion potential of the portion of fuel participating in the electrochemistry less both the heat transfer to the anode gas and the endothermic reformation process. The voltage is applied as a set-point and used in conjunction with the known power and temperature set-points 310, r(t), and the measured stack parameters, y(t), in a combination proportional-integral controller described by Eq. 2 to Eq. 5:

$$\begin{matrix}V \cdot i = \frac{i}{2 F} {h}_{rxn 1} - {( \dot{n} {c}_{p} Δ T )}_{A node} - \frac{i \cdot {\dot{n}}_{{CH}_{4}}}{{i}^{*} \cdot Cells} \cdot ( {h}_{rxn 2} + {h}_{rxn 3} ) & Eq . 1 \\ \hat{e} ( t ) = \frac{e ( t )}{r ( t )} = \frac{( r ( t ) - y ( t ) )}{r ( t )} & Eq . 2 \\ {\dot{n}}_{{CH}_{4}} = \{ IC \cdot {I}_{g} \int {\hat{e} ( t )}_{Power} \} & Eq . 3 \\ {i}^{*} = \{ IC \cdot {I}_{g} \int {\hat{e} ( t )}_{Voltage} \} & Eq . 4 \\ i = {i}^{*} \{ 1 + {P}_{g} \cdot {\hat{e} ( t )}_{Temperature} \} & Eq . 5\end{matrix}$$

In the above equations, V represents voltage, T represents temperature, i represents stack current, hᵣₓₙ₁, represents the heat released in the electrochemical reactions, hᵣₓₙ₂ and hᵣₓₙ₃ represent the simultaneous fuel reformation and water gas shift reactions occurring in the fuel processing, \dot{n} represents the fuel flow rate (shown using CH₄ in FIG. 5), and Cₚ the average fuel specific heat. As shown in FIG. 5, Eq. 2 (block 312) is used to acquire ê(t)_{Power}, ê(t)_{Voltage} and ê(t)_{Temperature}, which are respectively used as inputs for Eq. 3 (block 314), Eq. 4, (block 316), and Eq. 5 (block 318). The output of block 316, i, is used as an input along with ê(t)_{Temperature} in solving Eq. 5 at block 318. The outputs of blocks 314 and 318 (i and \dot{n}, respectively), are then used to drive operation of fuel cell (e.g. simultaneously adjust both fuel flow and current as a function of the predicted thermal balance between fuel processing and power generation). The above equations may be solved simultaneously to determine the fuel cell operating conditions under a range of power outputs.

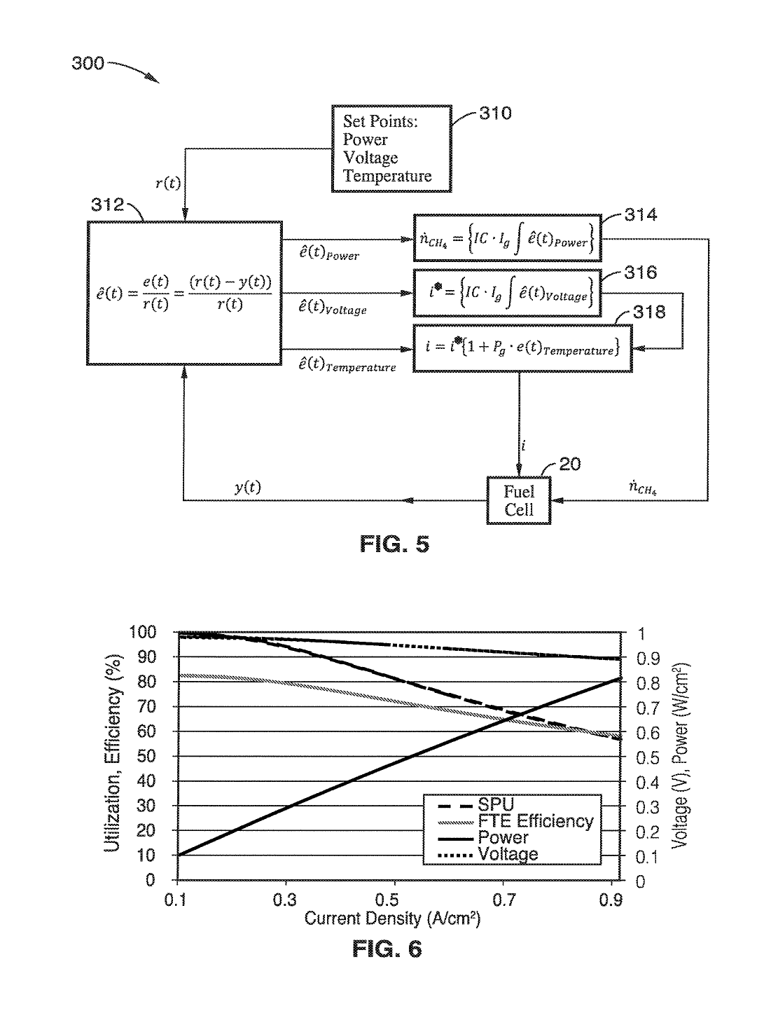

FIG. 6 illustrates the change in voltage, efficiency, and single pass fuel utilization with changing power.

Experimental tests were conducted with a fuel cell nominally capable of achieving a power density of 0.5 W/cm² at 0.70 Volts and 80% H₂ utilization. Table 1 illustrates the benefits of shifting operation to pure oxygen and pressurization to 10 atmospheres. The reference condition for an SOFC stack, outlined in case A, assumes no anode recirculation and 80% single pass fuel utilization (SPU).

The first feature of Oxy-FC operation is the shift to a pure oxygen cathode, case B. This increases the Nernst potential across the entire cell, and reduces cathode activation and diffusion losses which raises the voltage. Adjusting current and fuel flow to operate at the same power density and utilization results in a voltage increases from 0.7 to 0.817 volts. The shift to pure O₂ would require air-separation technology capable of generating 0.427 kg·h⁻¹ of pure O₂ for each kW of FC capacity.

The second feature of the Oxy-FC system is poly-generation, which is used to thermally balance this unsustainable condition above with additional fuel processing/reforming. Balancing the heat generation at this condition requires a 25% increase in fuel flow, reducing fuel utilization from 80% to 63.9%. The synergistic consequence is a beneficial increase in the average electrochemically active species (i.e., hydrogen) concentration in the bulk anode flow. This synergistic feedback results in a further increase in the operating voltage from 0.817 to 0.829 volts at the same power density, as shown in case D.

The third feature of the Oxy-FC concept is pressurization, which raises the Nernst potential and decreases activation and diffusion losses, and thus increases the voltage even further. Cases C and E illustrate the change from cases B and D when the fuel cell is pressurized to 10 atmospheres. At the same level of power generation the higher voltage generates less heat allowing the endothermic reforming to balance the stack heat generation at an SPU of 85.3%.

These 5 cases, A through E, assumed external pre-heating and humidification of the anode fuel stream. Generating the quantity of steam necessary would require substantial thermal energy. An alternative is to employ anode recirculation which simultaneously pre-heats the natural gas and supplies water vapor for the endothermic reforming. Cases A-E also assumed the anode fuel stream entered at the operating temperature of the fuel cell, and thus minimal thermal gradients were present. Cases F, G, and H utilize anode recirculation to provide steam, pre-heat the gas, and provide a portion of the cooling with a 100° C. temperature gradient across the length of the anode channels. Anode recirculation also modifies the bulk-stream concentration of reactants.

The combined impact of all three features is shown in case G. Fuel utilization increases to 90% despite single-pass utilization remaining nearly constant. Both current and the oxygen requirements decrease by 25% as voltage increases by 25%. An alternative higher power density condition is detailed in case H. While power density does not affect the thermodynamic analysis, the current results indicate a 50% increase in power can be realized from the reference SECA case without significantly affecting efficiency and perhaps resulting in better manufacturing economics. Raising the power output to 750 mW·cm⁻² lowers fuel utilization to 80% and SPU to 61.11%. This condition of case H would generate more hydrogen compared to the lower power density Oxy-FC system of the other cases.

The addition of anode recirculation makes the energy flow balance less intuitive. Table 2 presents a summary of the energy output for the cases F, G, and H normalized to 1 kJ of fuel input. The parasitic load of the ASU and HSU vary with scale, large systems being more efficient. Thus the lower end of the range in ASU parasitic load, ˜4%, corresponds to ultra large, ˜100 MW, systems using large commercial air separation technology. The upper end of the range, ˜40%, corresponds to fuel cell systems in the 50 kW size class.

Commercial cryogenic air separation technology does currently not exist at a scale small enough to integrate efficiently with smaller fuel cell systems, thus the alternative Oxy-FC system 100 of FIG. 2 may be implemented for smaller scale systems.

A survey of performance for the current art of air separation units was conducted, and the resulting trend of increasing efficiency with size, was utilized in the analysis. The smallest cryogenic units commercially available produce slightly less than 1 ton of O₂ per day, enough to supply a 100 kW fuel cell system. A 10 ton per day system could support a 1 MW plant with as little as 20% parasitic drag on the electrical output. At this scale, FTE efficiency is comparable to the current art of fuel cell systems for stationary power, though the system of the present description would allow for higher co-production efficiency when the hydrogen and carbon dioxide recovery is considered. At larger scales the reduced ASU parasitic and economics of scale fuel cell manufacturing could enable the system of the present description to compete effectively against established power plant technologies.

Embodiments of the present technology, such as the controller 300 detailed above with respect to FIG. 5, are described with reference to flowchart illustrations of methods and systems according to embodiments of the technology, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula(e), or computational depiction(s).

It will further be appreciated that the terms “programming” or “program executable” as used herein refer to one or more instructions that can be executed by a processor to perform a function as described herein. The instructions can be embodied in software, in firmware, or in a combination of software and firmware. The instructions can be stored local to the device in non-transitory media, or can be stored remotely such as on a server or all or a portion of the instructions can be stored locally and remotely. Instructions stored remotely can be downloaded (pushed) to the device by user initiation, or automatically based on one or more factors. It will further be appreciated that as used herein, that the terms processor, computer processor, central processing unit (CPU), and computer are used synonymously to denote a device capable of executing the instructions and communicating with input/output interfaces and/or peripheral devices.

From the description herein, it will be appreciated that that the present disclosure encompasses multiple embodiments which include, but are not limited to, the following:

1. A high temperature fuel cell system, comprising: a fuel cell stack; a source for generating high-purity oxygen for delivery to the fuel cell stack; an endothermic reformer coupled to the fuel cell stack; and wherein the reformer is configured for processing input hydrocarbon fuel to cool the fuel cell stack.

2. The system of any preceding embodiment, wherein the fuel cell stack comprises a closed-cell cathode.

3. The system of any preceding embodiment: wherein the source for generating high-purity oxygen comprises a cryogenic air separation unit that simultaneously generates liquid nitrogen and the high-purity oxygen; and wherein the high-purity oxygen comprises high-pressure oxygen for delivery to the cathode.

4. The system of any preceding embodiment: wherein the fuel cell stack comprises a molten carbonate fuel cell; and wherein the fuel cell system further comprises a source for recovering CO₂ configured for diluting the high-pressure oxygen for delivery to the cathode.

5. The system of any preceding embodiment: wherein the source for recovering CO₂ comprises a hydrogen separation unit; and wherein the hydrogen separation unit is configured to receive the liquid nitrogen generated from the cryogenic air separation unit for separating H₂ and CO₂ from an output stream of the fuel cell stack.

6. The system of any preceding embodiment, further comprising means for recovering H₂ and CO₂ from an output stream of the fuel cell stack.

7. The system of any preceding embodiment, wherein the means for recovering H₂ and CO₂ comprises a hydrogen separation unit is configured to receive the liquid nitrogen generated from the cryogenic air separation unit for separating H₂ and CO₂.

8. The system of any preceding embodiment: wherein the source for generating high-purity oxygen comprises an electrolyzer cell; and wherein the fuel cell system further comprises a second high temperature fuel cell stack for powering the electrolyzer cell.

9. The system of any preceding embodiment: wherein the fuel cell stack comprises an anode exhaust; and wherein the fuel cell system further comprises a heat exchanger coupled to the anode exhaust to generate steam or hot air to pre-heat the oxygen delivered to the cathode. 10. The system of any preceding embodiment: wherein the fuel cell stack comprises an anode exhaust; wherein the fuel cell system further comprises a reciprocating pump coupled to the anode exhaust; and wherein the reciprocating pump comprises variable valve timing to control mixture of a portion of residual anode exhaust and hydrocarbon fuel to pre-heat the hydrocarbon fuel delivered to the endothermic reformer.

11. The system of any preceding embodiment, wherein the reciprocating pump comprises a piston-cylinder reciprocating chamber configured to intermittently pressurize individual charges fed to the fuel cell stack.

12. The system of any preceding embodiment, further comprising a power/thermal management controller configured to balance fuel cell stack heat generation with a fuel processing heat sink.

13. The system of any preceding embodiment, wherein the reformer is configured to internally reform the hydrocarbon fuel to cool the fuel-cell stack.

14. The system of any preceding embodiment, wherein the reformer is configured to externally reform the hydrocarbon fuel while remaining thermally coupled to heat generation within the fuel cell stack.

15. A method for operating a high temperature fuel cell, comprising: generating high-purity oxygen for delivery to a fuel cell stack; and endothermically reforming a hydrocarbon fuel to cool the fuel cell stack.

16. The method of any preceding embodiment, wherein the fuel cell stack comprises a closed-cell cathode.

17. The method of any preceding embodiment: wherein generating high-purity oxygen comprises a cryogenically separating generating liquid nitrogen and the high-purity oxygen; and wherein the high-purity oxygen is delivered at a high-pressure to the cathode.

18. The method of any preceding embodiment, wherein the fuel cell stack comprises a molten carbonate fuel cell, the method further comprising: generating CO₂, and diluting the high-pressure oxygen with the CO₂ prior to delivery to the cathode.

19. The method of any preceding embodiment, wherein generating CO₂ comprises receiving the liquid nitrogen generated from the air separation unit and separating H₂ and CO₂ from an output stream of the fuel cell stack with a hydrogen separation unit.

20. The method of any preceding embodiment, further comprising recovering H₂ and CO₂ from an output stream of the fuel cell stack.

21. The method of any preceding embodiment, wherein recovering H₂ and CO₂ from an output stream of the fuel cell stack comprises: receiving the liquid nitrogen generated from the air separation unit; and separating H₂ and CO₂ from the output stream.

22. The method of any preceding embodiment: wherein the high-purity oxygen is generated via electrolysis; and wherein said electrolysis is powered via a second high temperature fuel cell stack.

23. The method of any preceding embodiment, wherein the fuel cell stack comprises an anode exhaust, the method further comprising:

generating steam or hot air from the anode exhaust to pre-heat the oxygen delivered to the cathode.

24. The method of any preceding embodiment, wherein the steam or hot air is generated from a heat exchanger.

25. The method of any preceding embodiment, wherein the fuel cell stack comprises an anode exhaust, the method further comprising: controlling mixture of a portion of residual anode exhaust and hydrocarbon fuel via variable valve timing to pre-heat the hydrocarbon fuel prior to endothermic reforming the fuel.

26. The method of any preceding embodiment, wherein pre-heating the hydrocarbon fuel further comprises intermittently pressurizing individual charges fed to the fuel cell stack.

27. The method of any preceding embodiment, further comprising: simultaneously adjusting both fuel flow and current to the fuel cell stack as a function of a predicted thermal balance between fuel processing and power generation associated with the fuel-cell stack.

28. The method of any preceding embodiment, wherein the fuel flow and current are adjusted according to the equation:

$$V \cdot i = \frac{i}{2 F} {h}_{rxn 1} - {( \dot{n} {c}_{p} Δ T )}_{Anode} - \frac{i \cdot {\dot{n}}_{{CH}_{4}}}{{i}^{*} \cdot Cells} \cdot ( {h}_{rxn 2} + {h}_{rxn 3} ) ; wherein$$

$$\hat{e} ( t ) = \frac{e ( t )}{r ( t )} = \frac{( r ( t ) - y ( t ) )}{r ( t )} ; {\dot{n}}_{{CH}_{4}} = \{ IC \cdot {I}_{g} \int {\hat{e} ( t )}_{Power} \} ;$$

$${i}^{*} = \{ IC \cdot {I}_{g} \int {\hat{e} ( t )}_{Voltage} \} ; and$$

$$i = {i}^{*} \{ 1 + {P}_{g} \cdot {\hat{e} ( t )}_{Temperature} \} .$$

29. The method of any preceding embodiment, wherein endothermically reforming the hydrocarbon fuel comprises internally reforming the hydrocarbon fuel to cool the fuel-cell stack.

30. The method of any preceding embodiment, wherein endothermically reforming the hydrocarbon fuel comprises externally reforming the hydrocarbon fuel while remaining thermally coupled to heat generation within the fuel cell stack.

31. The method of any preceding embodiment, wherein the fuel cell is operated at or near atmospheric pressure.

32. The method of any preceding embodiment, wherein the fuel cell operates at elevated pressure.

33. The method of any preceding embodiment, wherein the recovered hydrogen is utilized on site for additional power generation, heating, or chemical processes.

34. The method of any preceding embodiment, wherein the hydrogen recovered is pressurized and delivered to vehicle fueling stations.

35. The method of any preceding embodiment, wherein the recovered hydrogen is injected into a natural gas pipeline.

36. A high temperature fuel cell utilizing elevated oxygen concentrations in the cathode stream and incorporating thermal integration with an endothermic fuel processing component as the primary means of stack cooling and/or thermal management.

37. The fuel cell of any of the previous embodiments, wherein the endothermic fuel processing occurs in separate plate or channels from the electrochemically active plates and heat transfer occurs primarily through conduction.

38. The fuel cell of any of the previous embodiments, wherein a combined power/thermal management controller is applied which balances the fuel cell heat generation with the fuel processing heat sink.

39. The fuel cell of any of the previous embodiments, wherein cryogenic air separation generates the high purity oxygen for the cathode stream and liquid nitrogen for the carbon dioxide and hydrogen recovery.

40. The fuel cell of any of the previous embodiments, wherein the oxygen generation and hydrogen separation are provided by a secondary fuel cell—electrolyzer combination.

41. The fuel cell of any of the previous embodiments, wherein the oxidant stream is diluted with CO2 for use in a molten carbonate fuel cell.

42. The fuel cell of any of the previous embodiments, wherein the hydrogen recovered is pressurized and delivered to vehicle fueling stations or utilized on site for additional power generation, heating, or chemical processes.

43. An intermittently pressurized fuel cell fed individual charges of fuel from a piston-cylinder arrangement

44. The fuel cell of any of the previous embodiments, wherein the incoming fuel inlet is pre-heated and humidified from the exhaust gas residual of the previous cycle.

45. The high temperature fuel cell of any preceding embodiment, wherein the stack cooling is provided directly by internal reforming of the hydrocarbon fuel.

46. The high temperature fuel cell of any preceding embodiment, wherein the endothermic fuel processing occurs external to the stack but remains thermally coupled to the heat generation within the stack.

47. The high temperature fuel cell of any preceding embodiment, wherein the fuel inlet is pre-heated and supplied steam via anode exhaust gas recirculation.

48. The high temperature fuel cell of any preceding embodiment, wherein the fuel inlet exchanges heat with the anode exhaust via one or more heat exchangers

49. The high temperature fuel cell of any preceding embodiment, wherein the fuel cell is operated at or near atmospheric pressure.

50. The high temperature fuel cell of any preceding embodiment, wherein the fuel cell operates at elevated pressure.

51. The high temperature fuel cell of any preceding embodiment, wherein the hydrogen is recovered using alternative means of hydrogen separation.

52. The high temperature fuel cell of any preceding embodiment, wherein the recovered hydrogen is utilized on site for additional power generation, heating, or chemical processes.

53. The high temperature fuel cell of any preceding embodiment, wherein the hydrogen recovered is pressurized and delivered to vehicle fueling stations.

54. The high temperature fuel cell of any preceding embodiment, wherein the recovered hydrogen is injected into a natural gas pipeline.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1

| | | | Single Pass | | |
|---|---|---|---|---|---|
| | Voltage | Utilization | Utilization | Current | Oxygen |
| Case | (V) | (%) | (%) | (A/cm²) | (kg/kWh) |
| A | 0.7 | 80 | 80 | 0.715 | 0.427 |
| B | 0.817 | 80 | 80 | 0.612 | 0.365 |
| C | 0.956 | 80 | 80 | 0.523 | 0.312 |
| D | 0.829 | 63.9 | 63.9 | 0.603 | 0.36 |
| E | 0.954 | 85.3 | 85.3 | 0.524 | 0.312 |
| F | 0.826 | 70.0 | 39.7 | 0.606 | 0.362 |
| G | 0.943 | 89.6 | 79.3 | 0.53 | 0.316 |
| H | 0.9018 | 80 | 61.1 | 0.832 | 0.331 |

TABLE 2

| | Operating Condition: | | |
|---|---|---|---|
| | F: 1 atm, | G: 10 atm | H: 10 atm, |
| | .5 W/cm² | .5 W/cm² | .75 W/cm² |
| Electric | 0.5545 | 0.8125 | 0.6983 |
| Output | | | |
| Thermal >150° C. | 0.0506 | 0.0492 | 0.0470 |
| Thermal >25° C. | 0.0797 | 0.0703 | 0.0716 |
| H2 | 0.3552 | 0.1234 | 0.2312 |
| Recovery | | | |
| HSU | −0.014 | −0.013 | −0.011 |
| Parasitic | | | |
| ASU | −(.0333-0.1996) | −(.0403-.244) | −(.035-.2095) |
| Parasitic | | | |

1-7. (canceled)

8. The poly-generating fuel-cell system of claim 37, wherein the source of oxygen comprises an electrolyzer cell; and wherein the poly-generating fuel-cell system further comprises a second high temperature fuel-cell stack for powering the electrolyzer cell.

9. The poly-generating fuel-cell system of claim 1, further comprising a heat exchanger which receives at least a portion of anode exhaust gases and heat and transfers the heat to the source of oxygen.

10. The poly-generating fuel-cell system of claim 37, further comprising a reciprocating pump configured to pump anode exhaust gases; and wherein the reciprocating pump operates with variable valve timing so as to proportionately control an amount of the anode exhaust gases recirculated to the anode, and to humidify and pre-heat the hydrocarbon fuel delivered to the endothermic reformer.

11. The poly-generating fuel-cell system of claim 10, wherein the reciprocating pump comprises a piston-cylinder reciprocating chamber configured to intermittently pressurize individual charges fed to the high temperature fuel cell stack.

12. The poly-generating fuel-cell system of claim 37, further comprising a power/thermal management controller configured to balance fuel cell stack heat generation with a fuel processing heat sink.

13-35. (canceled)

36. The poly-generating fuel-cell system of claim 37, wherein the hydrocarbon fuel is natural gas, landfill gas, or digester gas.

37. A poly-generating fuel-cell system comprising
1) a high temperature fuel cell stack that produces an output stream of H₂ and CO₂, wherein the high temperature fuel-cell stack comprises:
a fuel cell,
an anode,
a closed-ended cathode, and
an anode exhaust;
and wherein the poly-generating fuel cell system further comprises:
2) a cryogenic air separation unit that simultaneously generates liquid nitrogen and high-purity oxygen comprising high-pressure oxygen;
3) a source of oxygen comprising a hydrogen separation unit configured to
i) recover H₂ and CO₂ from the output stream of the high temperature fuel cell stack, and
ii) separate recovered H₂ and CO₂ using the liquid nitrogen generated by the cryogenic air separation unit;
wherein the configuration of the source of oxygen raises oxygen utilization to 100% for the high temperature fuel cell stack;
4) a first endothermic reformer coupled to the high temperature fuel cell stack, wherein the first endothermic reformer is configured to
iii) receive a hydrocarbon fuel mixture,
iv) internally reform the hydrocarbon fuel mixture by converting the hydrocarbon fuel mixture into carbon monoxide, carbon dioxide, and hydrogen via steam reforming and water-gas-shift chemistry, thereby cooling the high temperature fuel cell stack; and
v) convey reformed fuel to the anode;
5) a first fuel stream path connected to the anode exhaust and configured to recirculate at least a portion of heat and steam output by the anode exhaust back to the first endothermic reformer, the first endothermic reformer having no input path except the first fuel stream path;
6) a second endothermic reformer; and
7) a second fuel stream path connected to the anode exhaust, wherein the second fuel stream path is configured to direct fuel to the second endothermic reformer.

38. The poly-generating fuel cell system of claim 37, wherein output from the anode exhaust comprises heat and steam, and wherein a hydrogen content of the steam is lower than a hydrogen content of the reformed fuel received from the first endothermic reformer and a water content of the steam is higher than that of the reformed fuel received from the first endothermic reformer.

39. The poly-generating fuel cell system of claim 37, wherein the second endothermic reformer is an external endothermic reformer that is thermally coupled to heat generation within the fuel cell stack.

40. The poly-generating fuel cell system of claim 37, wherein the fuel cell is a molten carbonate fuel cell and the source of oxygen is configured to
dilute the high-purity oxygen comprising high-pressure oxygen with the CO₂;
and
deliver diluted high-purity oxygen comprising high-pressure oxygen and CO₂ to the closed-ended cathode, thereby doubling the mass flow of CO₂.
